(19) United States
(12) Patent Application Publication
(10) Pub. No.: US 2024/0405293 A1
(43) Pub. Date: Dec. 5, 2024

(54) SECONDARY BATTERY, ELECTRONIC DEVICE, AND ELECTRIC TOOL

(71) Applicant: MURATA MANUFACTURING CO., LTD., Kyoto (JP)

(72) Inventor: Yasuaki HARA, Kyoto (JP)

(21) Appl. No.: 18/799,523

(22) Filed: Aug. 9, 2024

Related U.S. Application Data
(63) Continuation of application No. 17/842,003, filed on Jun. 16, 2022.
Application No. 17/842,003 is a continuation of application No. PCT/JP2021/000827, filed on Jan. 13, 2021.

(30) Foreign Application Priority Data
Jan. 23, 2020 (JP) 2020-009165

(51) Int. Cl. H01M 10/0587; H01M 50/531

(52) U.S. Cl. CPC H01M 10/0587; H01M 50/531

(57) ABSTRACT

Provided is a secondary battery. The secondary battery includes a positive electrode includes a first covered part covered with a positive electrode active material layer and a positive electrode active material non-covered part on a positive electrode foil, and a negative electrode includes a second covered part covered with a negative electrode active material layer and a negative electrode active material non-covered part on a negative electrode foil, an electrode wound body includes: a flat surface formed by bending each of the positive electrode active material non-covered part and the negative electrode active material non-covered part toward the central axis of the electrode wound body to have an overlap with each other; and a groove formed in the flat surface.

### CROSS REFERENCE TO RELATED APPLICATIONS

The present application is a continuation of U.S. patent application Ser. No. 17/842,003, filed on Jun. 16, 2022, which application is a continuation of PCT patent application no. PCT/JP2021/000827, filed on Jan. 13, 2021, which claims priority to Japanese patent application no. JP2020-009165 filed on Jan. 23, 2020, the entire contents of which are being incorporated herein by reference.

### BACKGROUND

The present disclosure generally relates to a secondary battery, an electronic device, and an electric tool.

Lithium ion batteries have been widely applied in automobiles, electric tools, and the like, and high-power characteristics have been required. As one of methods for producing this high power, high-rate discharge has been proposed. The high-rate discharge is discharge in which a relatively large current flows, and in such a case, the internal resistance of the battery has a problematic magnitude. Examples of the main factor for the internal resistance of the battery include resistances between a positive electrode foil or a negative electrode foil, and a current-collecting plate.

### SUMMARY

The present disclosure generally relates to a secondary battery, an electronic device, and an electric tool.

For high-rate discharge, there is a need to increase the thickness of the current-collecting plate for reducing the resistance value, but in this case, there is the problem of defective welding due to a separator damaged by the heat of laser welding or a hole formed in the positive electrode foil or the negative electrode foil. In addition, there is also the problem of complicated and unstable laser welding due to the presence of the protruded part.

Accordingly, an object of the present disclosure is to provide a battery including a current-collecting plate that has a structure that is low in internal resistance and can be subjected to welding stably.

The present disclosure provides a secondary battery according to an embodiment including: an electrode wound body that has a positive electrode and a negative electrode stacked with a separator interposed therebetween and has a wound structure; a positive electrode current-collecting plate; a negative electrode current-collecting plate; and a battery can accommodating the electrode wound body, the positive electrode current-collecting plate and the negative electrode current-collecting plate,
in which the positive electrode includes a first covered part covered with a positive electrode active material layer and a positive electrode active material non-covered part on a positive electrode foil,
the negative electrode includes a second covered part covered with a negative electrode active material layer and a negative electrode active material non-covered part on a negative electrode foil,
the electrode wound body includes a flat surface formed by bending each of the positive electrode active material non-covered part and the negative electrode active material non-covered part toward a central axis of the electrode wound body to have an overlap with each other, and a groove formed in the flat surface,
each of the positive electrode current-collecting plate and the negative electrode current-collecting plate includes a band-shaped part and a plate-shaped part,
each of the plate-shaped parts includes a first surface facing an end of the electrode wound body, and a second surface with a recess,
the positive electrode active material non-covered part is joined to the first surface of the plate-shaped part of the positive electrode current-collecting plate at a first end of the electrode wound body, and
the negative electrode active material non-covered part is joined to the first surface of the plate-shaped part of the negative electrode current-collecting plate at second end of the electrode wound body.

According to at least an embodiment of the present disclosure, the internal resistance of the battery can be reduced, or a high-power battery can be achieved. In addition, the stable production of such a battery can be achieved.

It is to be understood that the contents of the present disclosure are not to be construed as being limited by the effects illustrated in this specification. It should also be understood that the effects described in the present specification are only examples, and additional effects may be further provided.

### BRIEF DESCRIPTION OF THE FIGURES

FIG. 1 is a schematic sectional view of a battery according to an embodiment of the present disclosure.

FIG. 2 is a diagram illustrating an example of a relationship among a positive electrode, a negative electrode, and a separator disposed in an electrode wound body according to an embodiment of the present disclosure.

FIG. 3A is a perspective view of a positive electrode current-collecting plate according to an embodiment of the present disclosure, and FIG. 3B is an enlarged view of a circled part in FIG. 3A according to an embodiment of the present disclosure.

FIG. 4A to 4F are diagrams illustrating a process for assembling a battery according to an embodiment of the present disclosure.

FIG. 5A is a perspective view in which a part of an electrode wound body is cut away for the illustration of a part to be laser-welded according to an embodiment of the present disclosure, and FIG. 5B is an enlarged view of a circled part in FIG. 5A.

FIG. 6A is a perspective view of a positive electrode current-collecting plate or a negative electrode current-collecting plate according to an embodiment of the present disclosure, and FIG. 6B is a sectional view taken along the line AA′ in FIG. 6A and viewed from the arrow direction.

FIGS. 7A to 7E are diagrams illustrating modification examples according to an embodiment of the present disclosure, and FIGS. 7F and 7G are diagrams illustrating comparative examples.

FIG. 8 is a connection diagram for use in description of a battery pack as an application example according to an embodiment of the present disclosure.

FIG. 9 is a connection diagram for use in description of an electric tool as an application example according to an embodiment of the present disclosure.

FIG. 10 is a connection diagram for use in description of an electric vehicle as an application example according to an embodiment of the present disclosure.

### DETAILED DESCRIPTION

As described herein, the present disclosure will be described based on examples with reference to the drawings, but the present disclosure is not to be considered limited to the examples, and various numerical values and materials in the examples are considered by way of example.

The embodiment and the like described below are preferred specific examples of the present disclosure, and the contents of the present disclosure are not to be considered limited to the embodiments and the like.

In the embodiment of the present disclosure, a cylindrical lithium ion battery will be described as an example of the secondary battery. Obviously, any battery other than the lithium ion battery or a battery that has any shape other than the cylindrical shape may be used.

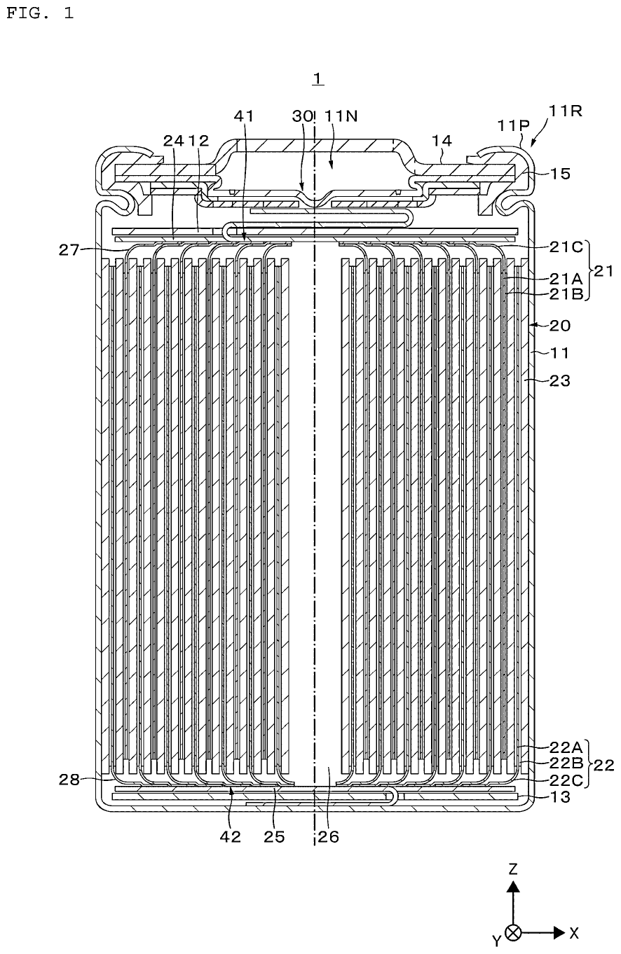

First, the overall configuration of the lithium ion battery will be described. FIG. 1 is a schematic sectional view of a lithium ion battery 1. The lithium ion battery 1 is, for example, a cylindrical lithium ion battery 1 that has an electrode wound body 20 is housed inside a battery can 11 as shown in FIG. 1.

Specifically, the lithium ion battery 1 includes, for example, a pair of insulating plates 12 and 13 and an electrode wound body 20 inside the cylindrical battery can 11. The lithium ion battery 1 may further, however, include, for example, any one of, or two or more of a positive temperature coefficient (PTC) element, a reinforcing member, and the like inside the battery can 11.

The battery can 11 is a member that mainly houses the electrode wound body 20. The battery can 11 is, for example, a cylindrical container with one end thereof opened and the other end thereof closed. More specifically, the battery can 11 has an opened end (open end 11N). The battery can 11 contains, for example, any one of, or two or more of metal materials such as iron, aluminum, and alloys thereof. The surface of the battery can 11 may be, however, plated with, for example, any one of, or two or more of metal materials such as nickel.

Each of the insulating plates 12 and 13 is, for example, a dish-shaped plate that has a surface perpendicular to the winding axis of the electrode wound body 20, that is, a surface perpendicular to the Z axis in FIG. 1. In addition, the insulating plates 12 and 13 are disposed so as to sandwich the electrode wound body 20 therebetween, for example.

The open end 11N of the battery can 11 has, for example, a battery cover 14 and a safety valve mechanism 30 are crimped with a gasket 15. The battery cover 14 serves as a “cover member” according to an embodiment of the present disclosure, and the gasket 15 serves as a “sealing member” according to an embodiment of the present disclosure. Thus, with the electrode wound body 20 and the like housed inside the battery can 11, the battery can 11 is sealed. Accordingly, the open end 11N of the battery can 11 has a crimped structure (crimped structure 11R) formed by the battery cover 14 and the safety valve mechanism 30 crimped with the gasket 15. More specifically, a bent part 11P is a so-called crimp part, and the crimped structure 11R is a so-called crimp structure.

The battery cover 14 is a member that closes the open end 11N of the battery can 11 mainly with the electrode wound body 20 and the like housed inside the battery can 11. The battery cover 14 contains, for example, the same material as the material that forms the battery can 11. The central region of the battery cover 14 protrudes in the +Z direction, for example. Thus, the region (peripheral region) of the battery cover 14 other than the central region has contact with, for example, the safety valve mechanism 30.

The gasket 15 is a member mainly interposed between the battery can 11 (bent part 11P) and the battery cover 14 to seal the gap between the bent part 11P and the battery cover 14. For example, asphalt or the like may be, however, applied to the surface of the gasket 15.

The gasket 15 contains, for example, any one of, or two or more of insulating materials. The types of the insulating materials are not particularly limited, and may be, for example, a polymer material such as a polybutylene terephthalate (PBT) and a polypropylene (PP). In particular, the insulating material is preferably a polybutylene terephthalate. This is because the gap between the bent part 11P and the battery cover 14 is sufficiently sealed while the battery can 11 and the battery cover 14 are electrically separated from each other.

The safety valve mechanism 30 mainly releases the sealed state of the battery can 11 to release the pressure (internal pressure) inside the battery can 11, if necessary, when the internal pressure is increased. The cause of the increase in the internal pressure of the battery can 11 is, for example, a gas generated due to a decomposition reaction of an electrolytic solution during charging or discharging.

For the cylindrical lithium ion battery, a band-shaped positive electrode 21 and a band-shaped negative electrode 22 are spirally wound with a separator 23 interposed therebetween, impregnated with an electrolytic solution, and housed in the battery can 11. The positive electrode 21 is obtained by forming a positive electrode active material layer 21B on one or both surfaces of a positive electrode foil 21A, and the material of the positive electrode foil 21A is, for example, a metal foil made of aluminum or an aluminum alloy. The negative electrode 22 is obtained by forming a negative electrode active material layer 22B on one or both surfaces of a negative electrode foil 22A, and the material of the negative electrode foil 22A is, for example, a metal foil made of nickel, a nickel alloy, copper, or a copper alloy. The separator 23 is a porous and insulating film, which enables transfer of substances such as ions and an electrolytic solution while electrically insulating the positive electrode 21 and the negative electrode 22.

The positive electrode active material layer 21B and the negative electrode active material layer 22B respectively cover most of the positive electrode foil 21A and the negative electrode foil 22A, but intentionally, neither of the layers covers one end periphery in the short axis direction of the band. Hereinafter, the part covered with no active material layer 21B or 22B is appropriately referred to as an active material non-covered part, whereas the part covered with the active material layer 21B or 22B is appropriately referred to as an active material covered part. In the cylindrical battery, the electrode wound body 20 is wound in such a manner that an active material non-covered part 21C of the positive electrode and an active material non-covered part 22C of the negative electrode are overlapped with each other with the separator 23 interposed therebetween so as to face in opposite directions.

FIG. 2 shows an example of a structure with the positive electrode 21, the negative electrode 22, and the separator 23 stacked before winding. The active material non-covered part 21C (the upper dotted part in FIG. 2) of the positive electrode has a width deunderstood by A, and the active material non-covered part 22C (the lower dotted part in FIG. 2) of the negative electrode has a width denoted by B. According to one embodiment, A>B is preferred, for example, A=7 (mm) and B=4 (mm). A part of the active material non-covered part 21C of the positive electrode, protruded from one end of the separator 23 in the width direction, has a length denoted by C, and a part of the active material non-covered part 22C of the negative electrode, protruded from the other end of the separator 23 in the width direction, has a length denoted by D. According to one embodiment, C>D is preferred, for example, C=4.5 (mm) and D=3 (mm).

The active material non-covered part 21C of the positive electrode is made of, for example, aluminum, whereas the active material non-covered part 22C of the negative electrode is made of, for example, copper, and thus, the active material non-covered part 21C of the positive electrode is typically softer (has a lower Young's modulus) than the active material non-covered part 22C of the negative electrode. Thus, according to one embodiment, A>B and C>D are more preferred, and in this case, when the active material non-covered part 21C of the positive electrode and the active material non-covered part 22C of the negative electrode are bent at the same pressure simultaneously from both electrode sides, the positive electrode 21 and the negative electrode 22 may be similar in the height of the bent part, measured from the tip of the separator 23. In this case, the active material non-covered parts 21C and 22C are bent to appropriately overlap with each other, thus allowing the active material non-covered parts 21C and 22C and current-collecting plates 24 and 25 to be easily joined by laser welding. Joining according to one embodiment means joining by laser welding, but the joining method is not limited to laser welding.

For the positive electrode 21, a section of 3 mm in width, including the boundary between the active material non-covered part 21C and the active material covered part 21B, is coated with an insulating layer 101 (gray region part in FIG. 2). Further, the whole region of the active material non-covered part 21C of the positive electrode, opposed the active material covered part 22B of the negative electrode with the separator interposed therebetween, is covered with the insulating layer 101. The insulating layer 101 has the effect of reliably preventing any internal short circuit of the battery 1 if any foreign matter enters between the active material covered part 22B of the negative electrode and the active material non-covered part 21C of the positive electrode. In addition, the insulating layer 101 has the effect of, when an impact is applied to the battery 1, absorbing the impact and reliably preventing the active material non-covered part 21C of the positive electrode from being bent or short-circuited with the negative electrode 22.

The central axis of the electrode wound body 20 has a through hole 26 formed. The through hole 26 is a hole for insertion of a winding core for assembling the electrode wound body 20 and an electrode rod for welding. The electrode wound body 20 is wound in an overlapping manner such that the active material non-covered part 21C of the positive electrode and the active material non-covered part 22C of the negative electrode face in the opposite directions, and thus, the active material non-covered part 21C of the positive electrode is gathered at one (end 41) of the ends of the electrode wound body 20, whereas the active material non-covered part 22C of the negative electrode is gathered at the other (end 42) of the ends of the electrode wound body 20. For improving contact with the current-collecting plates 24 and 25 for current extraction, the active material non-covered parts 21C and 22C are bent, and the ends 41 and 42 have flat surfaces. The bending directions are directions from the outer edges 27 and 28 of the ends 41 and 42 toward the through hole 26, and peripheral active material non-covered parts that are adjacent in the wound state are bent in a manner of overlapping with each other. In this specification, the “flat surface” includes not only a perfectly flat surface but also a surface with some unevenness and surface roughness to the extent that the active material non-covered part and the current-collecting plate can be joined.

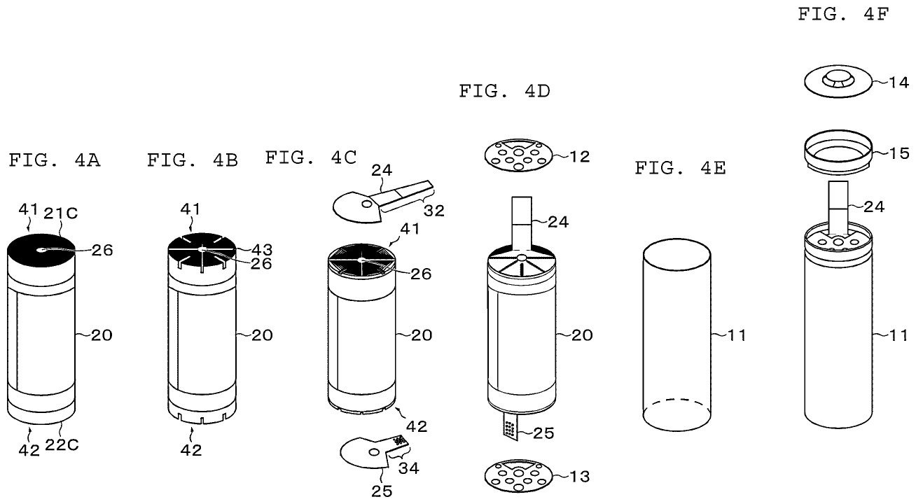

When each of the active material non-covered parts 21C and 22C are bent so as to have an overlap, it seems possible for the ends 41 and 42 to have flat surfaces, but if no processing is performed before bending, wrinkles or voids (voids, spaces) are generated at the ends 41 and 42 at the time of bending, and the ends 41 and 42 have no flat surfaces. In this regard, the “wrinkles” or “voids” are portions where the bent active material non-covered parts 21C and 22C are biased, thereby causing the ends 41 and 42 to have no flat surfaces. For preventing the generation of wrinkles and voids, grooves 43 (see, for example, FIG. 4B) are formed in radiation directions from the through hole 26. The groove 43 are grooves that extends from the outer edges 27 and 28 of the ends 41 and 42 to the through hole 26 in the central axis. The active material non-covered parts 21C and 22C have notches at the start of winding the positive electrode 21 and the negative electrode 22 near the through hole 26. This is for keeping the through hole 26 from being closed in the case of bending toward the through hole 26. The grooves 43 remain in the flat surfaces also after bending the active material non-covered parts 21C and 22C, and parts without the grooves 43 are joined (welded or the like) to the positive electrode current-collecting plate 24 or the negative electrode current-collecting plate 25. It is to be understood that the grooves 43 as well as the flat surfaces may be joined to a part of the current-collecting plates 24 and 25.

The detailed configuration of the electrode wound body 20, that is, the respective detailed configuration of the positive electrode 21, negative electrode 22, separator 23, and electrolytic solution will be described later.

In a common lithium ion battery, for example, a lead for current extraction is welded to each one of the positive electrode and negative electrode, but this is not suitable for high-rate discharge because of the high internal resistance of the battery and the temperature increased by heat generation of the lithium ion battery in the case of discharging. Thus, in the lithium ion battery according to one embodiment, the internal resistance of the battery is kept low by disposing the positive electrode current-collecting plate 24 and the negative electrode current-collecting plate 25 at the ends 41 and 42, and welding at multiple points to the active material non-covered parts 21C and 22C of the positive electrode and negative electrode present at the ends 41 and 42. The ends 41 and 42 are bent to form flat surfaces, which also contributes to the reduction in resistance.

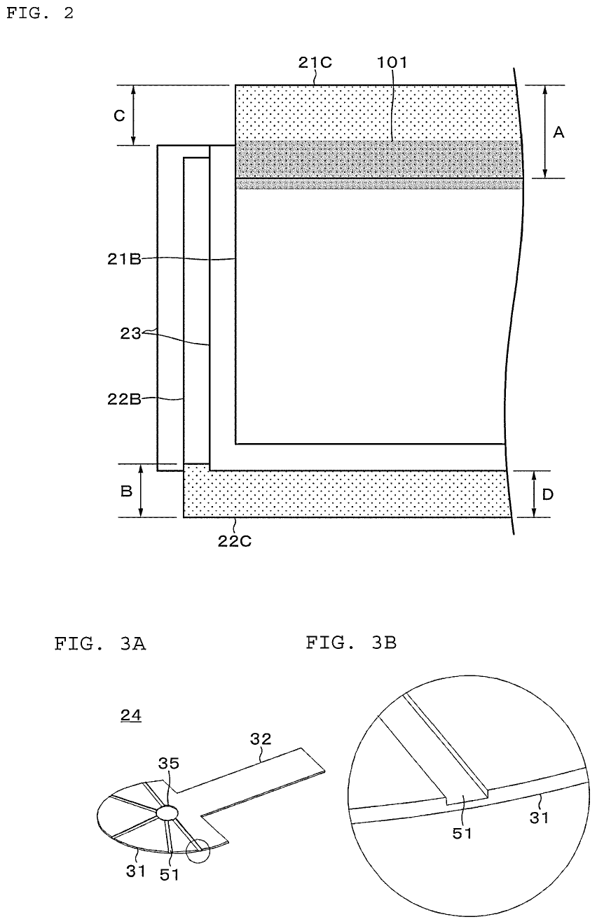

FIG. 3A and FIG. 3B show examples of the current-collecting plates. FIG. 3A is a perspective view of the positive electrode current-collecting plate 24, and FIG. 3B is an enlarged view of a circled part in FIG. 3A. The material of the positive electrode current-collecting plate 24 is, for example, a simple substance of aluminum or an aluminum alloy, or a composite thereof. As shown in FIG. 3A, the positive electrode current-collecting plate 24 has the shape of a flat fan-shaped plate-shaped part 31 with a rectangular band-shaped part 32 attached thereto. The plate-shaped part 31 has, near the center thereof, a hole 35 formed, and the position of the hole 35 corresponds to the through hole 26.

The positive electrode current-collecting plate 24 has thin-walled parts 51 radially extending from hole 35 of the plate-shaped part 31 to an outer edge. The thin-walled part 51 is provided in a groove shape. The plate-shaped part 31 has a facing surface facing an end of the electrode wound body and a non-facing surface with the thin-walled part. The thin-walled part is a recess formed on the non-facing surface. The thin-walled parts 51 are present at equal angular intervals of, for example, 45°. As shown in FIG. 3B, the width of the thin-walled part 51 is, for example, 1 to 1.5 mm. The thin-walled parts 51 are formed to serve as a welded sites. The positive electrode current-collecting plate 24 is joined to the end 41 by, for example, laser welding radially along the thin-walled parts 51 with the facing surface of the plate-shaped part 31 and the positive-electrode-side end 41 of the electrode wound body facing each other in close contact with each other. In this case, as viewed from the direction of the central axis of the electrode wound body 20, the positive electrode current-collecting plate 24 is disposed such that the thin-walled parts 51 have no overlaps with the grooves 43 at the end 41 of the electrode wound body 20.

As with the positive electrode current-collecting plate 24, the negative electrode current-collecting plate 25 (not shown) also has thin-walled parts 51. The material of the negative electrode current-collecting plate 25 is, for example, a simple substance nickel, a nickel alloy, copper, or a copper alloy, or a composite thereof. As with the positive electrode current-collecting plate 24, the negative electrode current-collecting plate 25 is joined to the end 42 by, for example, laser welding radially along the thin-walled parts 51 with the facing surface of the plate-shaped part of the negative electrode current-collecting plate 25 and the negative-electrode-side end 42 of the electrode wound body facing each other in close contact with each other. In this case, similarly, as viewed from the direction of the central axis of the electrode wound body 20, the negative electrode current-collecting plate 24 is disposed such that the thin-walled parts 51 have no overlaps with the grooves 43 at the end 42 of the electrode wound body 20.

The positive electrode active material layer includes at least a positive electrode material (positive electrode active material) capable of occluding and releasing lithium, and may further include a positive electrode binder, a positive electrode conductive agent, and the like. The positive electrode material is preferably a lithium-containing composite oxide or a lithium-containing phosphate compound. The lithium-containing composite oxide has, for example, a layered rock salt-type or spinel-type crystal structure. The lithium-containing phosphate compound has, for example, an olivine type.

The positive electrode binder includes a synthetic rubber or a polymer compounds. The synthetic rubbers may be styrene-butadiene rubbers, fluorine rubbers, ethylene propylene diene, and the like. Examples of the polymer compounds include a polyvinylidene fluoride (PVdF) and a polyimide.

The positive electrode conductive agent may be a carbon material such as graphite, carbon black, acetylene black, or Ketjen black. The positive electrode conductive agent may be, however, a metal material and a conductive polymer.

The surface of the negative electrode foil is preferably roughened for improving the adhesion to the negative electrode active material layer. The negative electrode active material layer includes at least a negative electrode material (negative electrode active material) capable of occluding and releasing lithium, and may further include a negative electrode binder, a negative electrode conductive agent, and the like.

The negative electrode material incudes, for example, a carbon material. The carbon materials may be, for example, graphitizable carbon, non-graphitizable carbon, graphite, low-crystallinity carbon, or amorphous carbon. The shape of the carbon has a fibrous, spherical, granular, or scaly shape.

The negative electrode material includes, for example, a metal-based material. Examples of the metal-based material include Li (lithium), Si (silicon), Sn (tin), Al (aluminum), Zr (zinc), and Ti (titanium). The metal-based element forms a compound, a mixture, or an alloy with another element, and examples thereof include a silicon oxide (SiOₓ (0<x≤2)), a silicon carbide (SiC) or an alloy of carbon and silicon, and a lithium titanate (LTO).

The separator 23 is a porous membrane containing a resin, and may be a laminated film of two or more porous films. The resin may be a polypropylene and a polyethylene. The separator 23 may include a resin layer on one or both surfaces of the porous membrane as a substrate layer. This is because the adhesion of the separator 23 to each of the positive electrode 21 and the negative electrode 22 is improved, thus keeping the electrode wound body 20 from warping.

The resin layer contains a resin such as PVdF. In the case of forming the resin layer, a solution in which a resin is dissolved in an organic solvent or the like is applied to the substrate layer, and then the substrate layer is dried. It is to be understood that after immersing the substrate layer in the solution, the base material layer may be dried. The resin layer preferably includes inorganic particles or organic particles from the viewpoint of improving the heat resistance and the safety of the battery. The type of the inorganic particles is an aluminum oxide, an aluminum nitride, an aluminum hydroxide, a magnesium hydroxide, boehmite, talc, silica, mica, or the like. In place of the resin layer, a surface layer containing inorganic particles as a main component may be used, which is formed by a sputtering method, an atomic layer deposition (ALD) method, or the like.

The electrolytic solution includes a solvent and an electrolyte salt, and may further include an additive and the like, if necessary. The solvent is a nonaqueous solvent such as an organic solvent, or water. The electrolytic solution including a nonaqueous solvent is referred to as a nonaqueous electrolytic solution. The nonaqueous solvent may be a cyclic carbonate, a chain carbonate, a lactone, a chain carboxylate, a nitrile (mononitrile), or the like.

Typical examples of the electrolyte salt are lithium salts, but a salt other than lithium salts may be contained. The lithium salt may be lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), dilithium hexafluorosilicate (Li₂SF₆), and the like. These salts can also be used in mixture, above all, the use of LiPF₆ and LiBF₄ in mixture is preferred from the viewpoint of improving battery characteristics. The content of the electrolyte salt is not particularly limited, but preferably 0.3 mol/kg to 3 mol/kg with respect to the solvent.

A method for manufacturing the lithium ion battery 1 according to one embodiment will be described with reference to FIG. 4A to FIG. 4F. First, a positive electrode active material was applied to the surface of the band-shaped positive electrode foil 21A to form the positive electrode 21, and a negative electrode active material was applied to the surface of the band-shaped negative electrode foil 22A to form the negative electrode 22. In this case, the active material non-covered parts 21C and 22C without the positive electrode active material or negative electrode active material applied were prepared at one end for each of the positive electrode 21 and negative electrode 22 in the widthwise direction, and notches were formed in parts of the active material non-covered parts 21C and 22C, corresponding to the winding starts at the time of winding. The positive electrode 21 and the negative electrode 22 were subjected to steps such as drying. Then, the electrodes were stacked with the separator 23 interposed therebetween such that the active material non-covered part 21C of the positive electrode and the active material non-covered part 22C of the negative electrode were oriented in opposite directions, and spirally wound so as to form the through hole 26 in the central axis and dispose the formed notches near the central axis, thereby preparing the electrode wound body 20 as shown in FIG. 4A.

Next, as shown in FIG. 4B, an end of a thin flat plate (for example, 0.5 mm in thickness) or the like was pressed perpendicularly to the ends 41 and 42 to locally bend the ends 41 and 42 and then prepare the grooves 43. In accordance with this method, the groove 43 extending toward the central axis was prepared in radiation directions from the through hole 26. The number of the grooves 43 and the arrangement, shown in FIG. 4B, is considered by way of example only. Then, as shown in FIG. 4C, the same pressure was applied simultaneously from both electrode sides in a direction substantially perpendicular to the ends 41 and 42 to bend the active material non-covered part 21C of the positive electrode and the active material non-covered part 22C of the negative electrode, and then form the ends 41 and 42 so as to have flat surfaces. In this case, the pressure was applied such that the active material non-covered parts at the ends 41 and 42 overlapped and then bent toward the through hole 26.

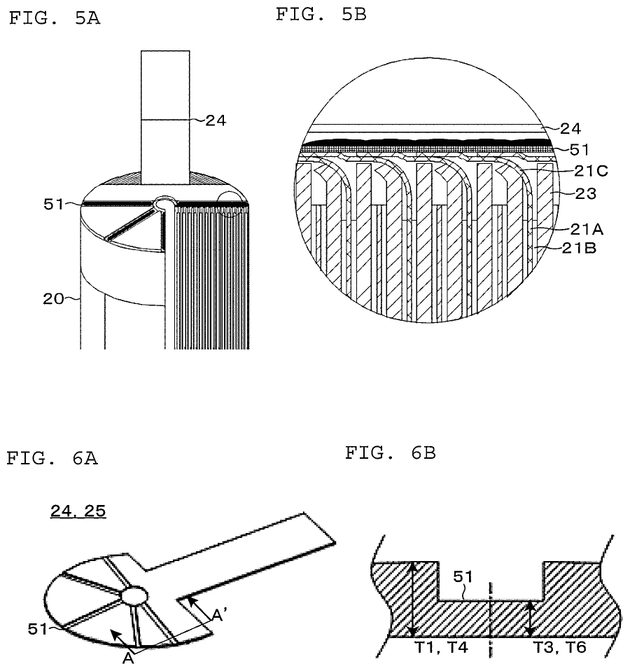

Thereafter, as shown in FIGS. 5A and 5B, plate-shaped part 31 of the positive electrode current-collecting plate 24 was placed over the end 41 so as to cause the surface without any thin-walled part 51 formed to face the end 41. The plate-shaped part 31 of the positive electrode current-collecting plate 24 was joined to the end 41 by laser welding at the position of the thin-walled part 51. Parts filled in black in FIGS. 5A and 5B indicate sites subjected to the laser welding. As with the positive electrode current-collecting plate 24, the plate-shaped part of the negative electrode current-collecting plate 25 was joined to the end 42 by laser welding.

Thereafter, as shown in FIG. 4D, the band-shaped parts of the current-collecting plates 24 and 25 were bent, and the insulating plates 12 and 13 were then placed respectively over the positive electrode current-collecting plate 24 and the negative electrode current-collecting plate 25. The electrode wound body 20 assembled as mentioned above was inserted into the battery can 11 shown in FIG. 4E. The band-shaped part 25 of the negative electrode current-collecting plate was welded to the bottom of the exterior can 11. The band-shaped part 24 of the positive electrode current-collecting plate was welded and connected to the safety valve mechanism 30. After injecting an electrolytic solution into the battery can 11, sealing was performed with the gasket 15 and the battery cover 14 as shown in FIG. 4F.

### EXAMPLES

The present disclosure will be specifically described with reference to examples, with the use of the lithium ion battery 1 prepared in the manner mentioned above. It is to be understood that the present disclosure is not to be considered limited to the examples described below.

The material of the positive electrode current-collecting plate 24 was an aluminum alloy, and the material of the negative electrode current-collecting plate 25 was a copper alloy. The battery was 21700 (diameter: 21 mm, length: 70 mm) in size. According to Example 1 to 6, the sectional shape of the thin-walled part 51 was made into a quadrangular shape for the positive electrode current-collecting plate 24 and the negative electrode current-collecting plate 25, and according to Comparative Example 1 to 6, no thin-walled part 51 was fabricated for the positive electrode current-collecting plate 24 or the negative electrode current-collecting plate 25 (without any thin-walled part).

As shown in FIG. 1 and FIGS. 6A and 6B, the thickness of the positive electrode current-collecting plate 24 (the thickness of the plate-shaped part 31 excluding the thin-walled part 51) was denoted by T1, the thickness of the active material non-covered part 21C of the positive electrode foil was denoted by T2, the thickness of the thin-walled part 51 of the positive electrode current-collecting plate 24 was denoted by T3, the thickness of the negative electrode current-collecting plate 25 (the thickness of the plate-shaped part excluding the thin-walled part 51) was denoted by T4, the thickness of the active material non-covered part 22C of the negative electrode was denoted by T5, and the thickness of the thin-walled part 51 of the negative electrode current-collecting plate 25 was denoted by T6.

### Example 1

T1 was adjusted to be 200 μm, T2 was adjusted to be 10 μm, T3 was adjusted to be 150 μm, T4 was adjusted to be 150 μm, T5 was adjusted to be 10 μm, and T6 was adjusted to be 130 μm.

### Example 2

T1 was adjusted to be 150 μm, T2 was adjusted to be 10 μm, T3 was adjusted to be 100 μm, T4 was adjusted to be 100 μm, T5 was adjusted to be 10 μm, and T6 was adjusted to be 80 μm.

### Example 3

T1 was adjusted to be 100 μm, T2 was adjusted to be 10 μm, T3 was adjusted to be 70 μm, T4 was adjusted to be 80 μm, T5 was adjusted to be 10 μm, and T6 was adjusted to be 60 μm.

### Example 4

T1 was adjusted to be 200 μm, T2 was adjusted to be 13 μm, T3 was adjusted to be 150 μm, T4 was adjusted to be 150 μm, T5 was adjusted to be 8 μm, and T6 was adjusted to be 130 μm.

### Example 5

T1 was adjusted to be 150 μm, T2 was adjusted to be 13 μm, T3 was adjusted to be 100 μm, T4 was adjusted to be 100 μm, T5 was adjusted to be 8 μm, and T6 was adjusted to be 80 μm.

### Example 6

T1 was adjusted to be 100 μm, T2 was adjusted to be 13 μm, T3 was adjusted to be 70 μm, T4 was adjusted to be 80 μm, T5 was adjusted to be 8 μm, and T6 was adjusted to be 60 μm.

### Comparative Example 1

T1 was adjusted to be 200 μm, T2 was adjusted to be 10 μm, T3 was adjusted to be 200 μm, T4 was adjusted to be 150 μm, T5 was adjusted to be 10 μm, and T6 was adjusted to be 150 μm.

### Comparative Example 2

T1 was adjusted to be 150 μm, T2 was adjusted to be 10 μm, T3 was adjusted to be 150 μm, T4 was adjusted to be 100 μm, T5 was adjusted to be 10 μm, and T6 was adjusted to be 100 μm.

### Comparative Example 3

T1 was adjusted to be 100 μm, T2 was adjusted to be 10 μm, T3 was adjusted to be 100 μm, T4 was adjusted to be 80 μm, T5 was adjusted to be 10 μm, and T6 was adjusted to be 80 μm.

### Comparative Example 4

T1 was adjusted to be 200 μm, T2 was adjusted to be 13 μm, T3 was adjusted to be 200 μm, T4 was adjusted to be 150 μm, T5 was adjusted to be 8 μm, and T6 was adjusted to be 150 μm.

### Comparative Example 5

T1 was adjusted to be 150 μm, T2 was adjusted to be 13 μm, T3 was adjusted to be 150 μm, T4 was adjusted to be 100 μm, T5 was adjusted to be 8 μm, and T6 was adjusted to be 100 μm.

### Comparative Example 6

T1 was adjusted to be 100 μm, T2 was adjusted to be 13 μm, T3 was adjusted to be 100 μm, T4 was adjusted to be 80 μm, T5 was adjusted to be 8 μm, and T6 was adjusted to be 80 μm.

The results of evaluating the batteries are shown in Table 1. The batteries were each evaluated in accordance with the welding condition range for the positive electrode, the welding condition range for the negative electrode, and the internal resistance (DCR) of the battery. The internal resistance (DCR) is obtained by calculating the slope of the voltage in the case of increasing the discharge current from 0 (A) to 100 (A) in 5 seconds. The welding condition range is a welding power range for successful laser welding for the positive electrode current-collecting plate 24 and the active material non-covered part 21C of the positive electrode, or a welding power range for successful laser welding for the negative electrode current-collecting plate 25 and the active material non-covered part 22C of the negative electrode. In order not to cause defects due to fluctuations in the power of the laser welding machine in mass production processes for batteries, the welding condition range desirably falls within the range of 1 kw or more. Furthermore, as a battery for high rate discharge, a battery that is low in internal resistance is desirable. Accordingly, an example in which the welding condition range of the positive electrode and the welding condition range of the negative electrode were both in the range of 1 kw or more and the battery was 10.5 mΩ or lower in internal resistance was determined to be OK as a comprehensive assessment, otherwise, the example was determined to NG as a comprehensive assessment.

TABLE 1

| | | | Thickness T3 | Shape of | Thickness | |
|---|---|---|---|---|---|---|
| | Thickness | Thickness | of Thin- | Thin- | T5 of | Thickness |
| | T2 of Active | T1 of | walled Part | walled | Active | T4 of |
| | Material | Positive | of Positive | Part of | Material | Negative |
| | Non-covered | Electrode | Electrode | Positive | Non-covered | Electrode |
| | Part of | Current- | Current- | Electrode | Part of | Current- |
| | Positive | collecting | collecting | Current- | Negative | collecting |
| | Electrode | Plate | Plate | collecting | Electrode | Plate |
| | (μm) | (μm) | (μm) | Plate | (μm) | (μm) |
| Example 1 | 10 | 200 | 150 | Quadrangular | 10 | 150 |
| Example 2 | 10 | 150 | 100 | Quadrangular | 10 | 100 |
| Example 3 | 10 | 100 | 70 | Quadrangular | 10 | 80 |
| Example 4 | 13 | 200 | 150 | Quadrangular | 8 | 150 |
| Example 5 | 13 | 150 | 100 | Quadrangular | 8 | 100 |
| Example 6 | 13 | 100 | 70 | Quadrangular | 8 | 80 |
| Comparative | 10 | 200 | 200 | No | 10 | 150 |
| Example 1 | | | | | | |
| Comparative | 10 | 150 | 150 | No | 10 | 100 |
| Example 2 | | | | | | |
| Comparative | 10 | 100 | 100 | No | 10 | 80 |
| Example 3 | | | | | | |
| Comparative | 13 | 200 | 200 | No | 8 | 150 |
| Example 4 | | | | | | |
| Comparative | 13 | 150 | 150 | No | 8 | 100 |
| Example 5 | | | | | | |
| Comparative | 13 | 100 | 100 | No | 8 | 80 |
| Example 6 | | | | | | |
| | Thickness | Shape of | | | | |
| | T6 of Thin- | Thin- | | | | |
| | walled Part | walled | | | | |
| | of Current | Part of | Welding | Welding | | |
| | Collecting | Negative | Condition | Condition | Internal | |
| | Plate of | Electrode | Range for | Range for | Resistance | |
| | Negative | Current- | Positive | Negative | DCR of | |
| | Electrode | collecting | Electrode | Electrode | Battery | Comprehensive |
| | (μm) | Plate | (kw) | (kw) | (mΩ) | Assessment |
| Example 1 | 130 | Quadrangular | 4.5~6.0 | 3.5~4.6 | 9.582 | OK |
| Example 2 | 80 | Quadrangular | 3.3~5.8 | 3.0~4.3 | 9.904 | OK |
| Example 3 | 60 | Quadrangular | 2.5~5.5 | 2.7~4.0 | 10.405 | OK |
| Example 4 | 130 | Quadrangular | 5.0~6.2 | 3.3~4.4 | 9.562 | OK |
| Example 5 | 80 | Quadrangular | 4.1~6.0 | 2.6~4.3 | 9.889 | OK |
| Example 6 | 60 | Quadrangular | 3.6~5.8 | 2.0~4.1 | 10.275 | OK |
| Comparative | 150 | No | 5.5~6.3 | 4.3~4.7 | 9.851 | NG |
| Example 1 | | | | | | |
| Comparative | 100 | No | 4.6~5.9 | 3.4~4.3 | 10.301 | NG |
| Example 2 | | | | | | |
| Comparative | 80 | No | 3.2~5.8 | 2.8~4.2 | 10.665 | NG |
| Example 3 | | | | | | |
| Comparative | 150 | No | 5.9~6.3 | 3.9~4.4 | 9.822 | NG |
| Example 4 | | | | | | |
| Comparative | 100 | No | 5.1~6.0 | 3.3~4.3 | 10.261 | NG |
| Example 5 | | | | | | |
| Comparative | 80 | No | 4.3~5.9 | 2.4~4.1 | 10.625 | NG |
| Example 6 | | | | | | |

The comprehensive assessment was OK with the welding condition ranges of 1 kw or more and the battery 1 of 10.5 mΩ or lower in internal resistance in Example 1 to 6, whereas the comprehensive assessment was NG with the welding condition ranges less than 1 kw or the battery of higher than 10.5 mΩ in internal resistance in Comparative Example 1 to 6. In Examples 1 to 6, the thin-walled parts were provided at the sites to be welded, and the energy input to the parts welded in the laser welding step can be thus presumed to have been efficiently transferred to the welded parts. As a result, the expanded range of the energy required for the welding and the further increased penetration depths of the welded parts can be presumed to have reduced the resistance. Accordingly, from Table 1, it can be determined that when the positive electrode current-collecting plate 24 and the negative electrode current-collecting plate 25 have thin-walled parts 51, with T2<T3 and T5<T6, the positive electrode current-collecting plate 24 and negative electrode current-collecting plate 25 of battery 1 have low internal resistances and have structures that can be welded stably.

While the embodiment of the present disclosure have been concretely described above, the contents of the present disclosure are not to be considered limited to the embodiment described above, and it is possible to make various modifications based on technical idea of the present disclosure.

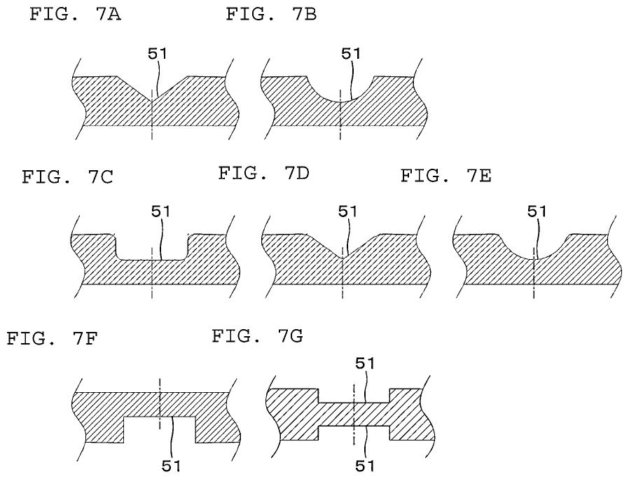

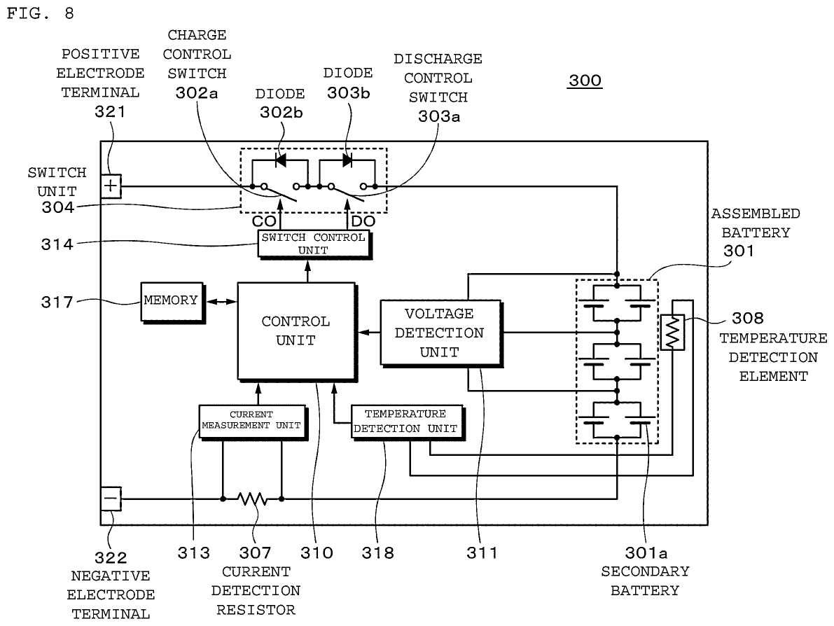

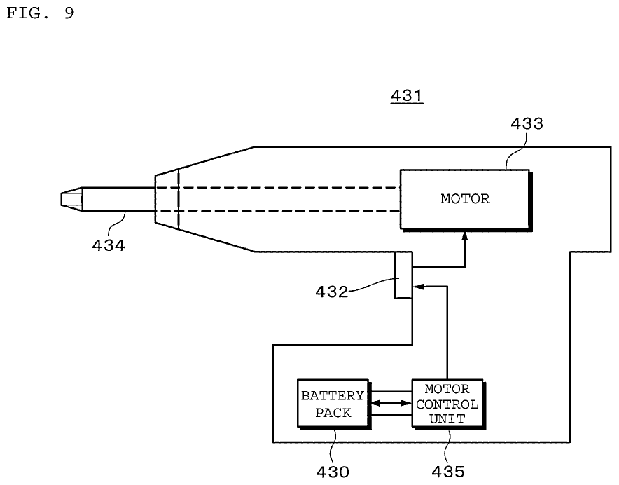

FIGS. 7A to 7E are modification examples of the sectional view taken along the line AA′ in FIG. 6A and viewed from the arrow direction. In this regard, the lower surface of the sectional shape of the plate-shaped part illustrated corresponds to a surface facing each of the ends 41 and 42 of the electrode wound body 20, and the upper surface thereof corresponds to a non-facing surface. The recess of the plate-shaped part is formed only on the non-facing surface. The facing surface of the plate-shaped part has no recess, and the facing surface is thus likely to be brought into close contact with the ends 41 and 42 of the electrode wound body 20. As shown in FIGS. 7A to 7E, the thin-walled parts 51 of the positive electrode current-collecting plate 24 and negative electrode current-collecting plate 25 may have a triangular or arcuate sectional shape, or a quadrangular, triangular, or arcuate sectional shape with a rounded corner. The thin-walled parts 51 of the positive electrode current-collecting plate 24 and negative electrode current-collecting plate 25 may have a polygonal sectional shape other than any triangular or quadrangular sectional shape.

FIGS. 7F and 7G are other comparative examples. In this regard, the lower surface of the sectional shape of the plate-shaped part illustrated corresponds to a surface facing each of the ends 41 and 42 of the electrode wound body 20, and the upper surface thereof corresponds to a non-facing surface. In FIGS. 7F and 7G, the facing surface of the plate-shaped part has a recess, and will have a gap provided when the facing surface faces the end 41 or 42 of the electrode wound body 20. Thus, defects are likely to be generated during laser welding.

The battery size is 21700 as an example, but other sizes may be employed.

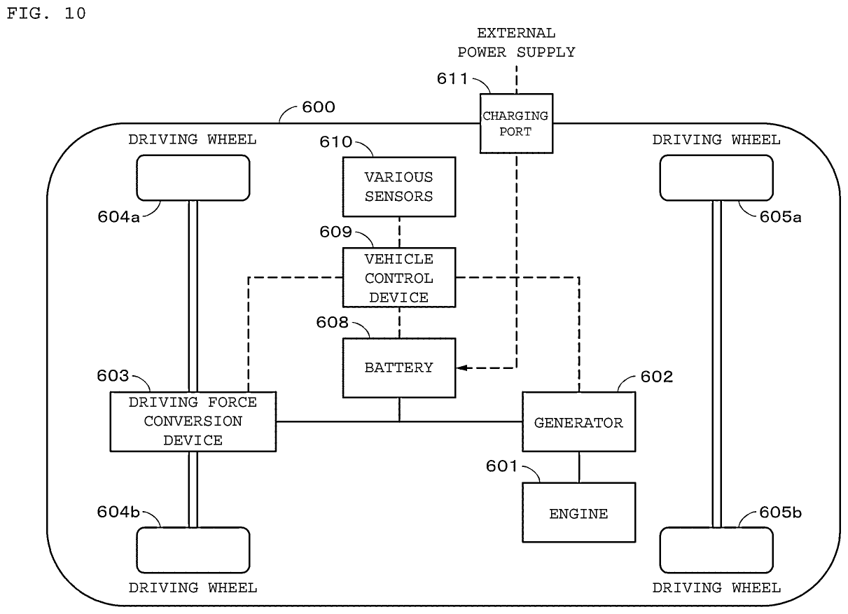

FIG. 8 is a block diagram illustrating a circuit configuration example in the case of applying a secondary battery according to an embodiment or an example of the present disclosure to a battery pack 300. The battery pack 300 includes an assembled battery 301, a switch unit 304 including a charge control switch 302a and a discharge control switch 303a, a current detection resistor 307, a temperature detection element 308, and a control unit 310. The control unit 310 controls each device, and is further capable of performing charge/discharge control at the time of abnormal heat generation, and calculating and correcting the remaining capacity of the battery pack 300. The positive electrode terminal 321 and negative electrode terminal 322 of the battery pack 300 are connected to a charger or an electronic device for charge/discharge.

The assembled battery 301 has a plurality of secondary batteries 301a connected in series and/or in parallel. FIG. 8 shows therein, as an example, a case where six secondary batteries 301a are connected so as to arrange two batteries in parallel and three batteries in series (2P3S).

A temperature detection unit 318 is connected to the temperature detection element 308 (for example, a thermistor), for measuring the temperature of the assembled battery 301 or the battery pack 300, and then supplying the measured temperature to the control unit 310. The voltage detection unit 311 measures the voltages of the assembled battery 301 and of the secondary batteries 301a constituting the assembled battery, performs A/D conversion of the measured voltages, and supplies the converted voltages to the control unit 310. A current measurement unit 313 measures a current with the use of the current detection resistor 307, and supplies the measured current to the control unit 310.

The switch control unit 314 controls the charge control switch 302a and discharge control switch 303a of the switch unit 304, based on the voltages and current input from the voltage detection unit 311 and the current measurement unit 313. The switch control unit 314 transmits an OFF control signal to the switch unit 304 when the secondary battery 301a reaches a voltage equal to or higher than an overcharge detection voltage (for example, 4.20 V±0.05 V) or equal to or lower than an overdischarge detection voltage (2.4 V±0.1 V), thereby preventing overcharge or overdischarge.

After the charge control switch 302a or the discharge control switch 303a is turned off, charge or discharge is allowed only through the diode 302b or the diode 303b. For the charge/discharge switch, a semiconductor switch such as a MOSFET can be used. It is to be understood that the switch unit 304 is provided on the positive side in FIG. 8, but may be provided on the negative side.

The memory 317 includes a RAM and a ROM, and stores and rewrites the values of the battery characteristics calculated by the control unit 310, the full charge capacity, the remaining capacity, and the like.

The above-described secondary battery according to an embodiment or an example of the present disclosure can be mounted on and used to supply electric power to electronic devices and electrical transportation devices, and devices such as electric storage devices.

Examples of the electronic devices include lap-top computers, smartphones, tablet terminals, PDAs (personal digital assistants), mobile phones, wearable terminals, digital still cameras, electronic books, music players, game machines, hearing aids, electric tools, televisions, lighting devices, toys, medical devices, and robots. In addition, the electric transportation device, electric storage devices, electric tool, and electric unmanned aircraft as described later can also be included in the electronic devices in a broad sense.

Examples of the electrical transportation devices include electric automobiles (including hybrid automobiles), electric motorbikes, electric assist bicycles, electric buses, electric carts, automatic guided vehicles (AGVs) and railway vehicles. In addition, the examples also include electric passenger aircraft and electric unmanned aircraft for transportation. The secondary battery according to the present disclosure is used not only as a driving power supply for the examples, but also as an auxiliary power supply, an energy regeneration power supply, and the like.

Examples of the electric storage devices include electric storage modules for commercial use or home use, and power supplies for power storage for architectural structures such as houses, buildings, and offices, or power generation facilities.

An example of an electric driver as an electric tool to which the present disclosure can be applied will be schematically described with reference to FIG. 9. An electric driver 431 is provided with a motor 433 that transmits rotative power to a shaft 434 and a trigger switch 432 operated by a user. A battery pack 430 according to the present disclosure and a motor control unit 435 are housed in a lower housing of a handle of the electric driver 431. The battery pack 430 is built in the electric driver, or detachable from the electric driver 431.

The battery pack 430 and the motor control unit 435 each may include a microcomputer (not shown), such that charge/discharge information of the battery pack 430 can be communicated with each other. The motor control unit 435 can control the operation of the motor 433, and cut off the power supply to the motor 433 at the time of abnormality such as overdischarge.

FIG. 10 schematically illustrates a configuration example of a hybrid vehicle (HV) that employs a series hybrid system to which the present disclosure is applied, as an example of applying the present disclosure to an electric storage system for an electric vehicle. The series hybrid system is intended for a vehicle that runs on an electric power-driving force conversion device, with the use of electric power generated by a generator powered by an engine, or the electric power stored once in the battery.

The hybrid vehicle 600 carries an engine 601, a generator 602, the electric power-driving force conversion device 603 (direct-current motor or alternate-current motor, hereinafter referred to simply as a “motor 603”), a driving wheel 604a, a driving wheel 604b, a wheel 605a, a wheel 605b, a battery 608, a vehicle control device 609, various sensors 610, and a charging port 611. As the battery 608, the battery pack 300 according to the present disclosure or an electric storage module mounted with a plurality of secondary batteries according to the present disclosure can be applied.

The motor 603 is operated by the electric power of the battery 608, and the torque of the motor 603 is transmitted to the driving wheels 604a and 604b. The torque produced by the engine 601 makes it possible to reserve, in the battery 608, the electric power generated by the generator 602. The various sensors 610 control the engine rotation speed via the vehicle control device 609, and control the position of a throttle valve, not shown.

When the hybrid vehicle 600 is decelerated by a braking mechanism, not shown, the resistance force during the deceleration is applied as torque to the motor 603, and the regenerative electric power generated by the torque is reserved in the battery 608. The battery 608 is connected to an external power supply through the charging port 611 of the hybrid vehicle 600, thereby making charge possible. Such an HV vehicle is referred to as a plug-in hybrid vehicle (PHV or PHEV).

It is to be understood that the secondary battery according to the present disclosure can also be applied to a downsized primary battery, and then used as a power supply for a pneumatic sensor system (TPMS: Tire Pressure Monitoring System) built in the wheels 604 and 605.

Although the series hybrid vehicle has been described above as an example, the present disclosure can be also applied to a parallel system in which an engine and a motor are used in combination or a hybrid vehicle in which a series system and a parallel system are combined. Furthermore, the present disclosure can be also applied to electric vehicles (EVs or BEVs) that run on driving by only a driving motor without using any engine, and fuel cell vehicles (FCVs).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a first electrode, a second electrode, and a separator interposed therebetween, and having a first end and a second end; and
a first electrode current collector plate connected to the first end; and
a second electrode current collector plate connected to the second end, wherein
the first electrode includes a first electrode foil, and a first electrode active material layer covering a part of the first electrode foil,
the first electrode includes a first electrode covered part in which the first electrode foil is covered with the first electrode active material layer, and a first electrode exposed part exposed from the first electrode active material layer,
the first electrode exposed part is bent and includes first electrode-foil adjacent portions adjacent to each other at a the first end, and
the separator is spaced from the first electrode current collector plate.

2. The secondary battery according to claim 1, wherein the second electrode includes a second electrode foil, and a second electrode active material layer covering a part of the second electrode foil, and
an end of the separator is between the first current electrode collector and the second active material layer.

3. The secondary battery according to claim 1, wherein
the second electrode includes a second electrode foil, and a second electrode active material layer covering a part of the second electrode foil, and
an end of the separator is between the first adjacent portions and the second active material layer.

4. The secondary battery according to claim 1, wherein the secondary battery has a cylindrical shape in outer appearance.

5. The secondary battery according to claim 1, wherein
the first electrode comprises a positive electrode,
the second electrode comprises a negative electrode, and
the second electrode includes a second electrode foil, and a second electrode active material layer covering a part of the second electrode foil,
the second electrode includes a second electrode covered part in which the second electrode foil is covered with the second electrode active material layer, and a second electrode exposed part exposed from the second electrode active material layer, and
the first electrode exposed part has a width greater than a width of the second electrode exposed part.

6. The secondary battery according to claim 1, wherein
the second electrode includes a second electrode foil, and a second electrode active material layer covering a part of the second electrode foil;
the second electrode includes a second electrode covered part in which the second electrode foil is covered with the second electrode active material layer, and a second electrode exposed part exposed from the second electrode active material layer; and
a portion, of the first electrode exposed part, that protrudes from a first edge in a width direction of the separator has a length greater than a length of a portion, of the second electrode exposed part, that protrudes from a second edge in the width direction of the separator.

7. The secondary battery according to claim 1, wherein
the first electrode comprises a positive electrode, the second electrode comprises a negative electrode, and the second electrode includes a second electrode foil, and a second electrode active material layer covering a part of the second electrode foil, and
the first electrode foil has a Young's modulus lower than a Young's modulus of the second electrode foil.

8. The secondary battery according to claim 1, wherein the second electrode includes a second electrode foil, and a second electrode active material layer covering a part of the second electrode foil,
the first electrode foil includes aluminum, and
the second electrode foil includes copper.

9. The secondary battery according to claim 1, wherein
each of the first end and the second end is provided with one or more grooves.

10. The secondary battery comprising:
an electrode wound body including a first electrode, a second electrode, and a separator interposed therebetween, and having a first end and a second end;
a first electrode current collector plate is connected to the first end; and
a second electrode current collector plate is connected to the second end,
wherein
the second electrode includes a second electrode foil, and a second electrode active material layer covering a part of the second electrode foil,
the second electrode includes a second electrode covered part in which the second electrode foil is covered with the second electrode active material layer, and a second electrode exposed part exposed from the first electrode active material layer,
the first electrode exposed part is bent and includes first electrode-foil adjacent portions adjacent to each other at the first end,
a part of the separator is bent, and
the separator is spaced from the second electrode current collector plate.

11. The secondary battery according to claim 10, wherein the first electrode includes a first electrode foil, and a first electrode active material layer covering a part of the first electrode foil, and
an end of the separator is between the second current electrode collector and the first active material layer.

12. The secondary battery according to claim 10, wherein
the first electrode includes a first electrode foil, and a first electrode active material layer covering a part of the first electrode foil, and
an end of the separator is between the second adjacent portions and the first active material layer.

13. The secondary battery according to claim 10, wherein the secondary battery has a cylindrical shape in outer appearance.

14. The secondary battery according to claim 10, wherein
the first electrode comprises a positive electrode,
the second electrode comprises a negative electrode,
the first electrode includes a first electrode foil, and a first electrode active material layer covering a part of the first electrode foil,
the first electrode includes a first electrode covered part in which the first electrode foil is covered with the first electrode active material layer, and a first electrode exposed part exposed from the first electrode active material layer, and
the first electrode exposed part has a width greater than a width of the second electrode exposed part.

15. The secondary battery according to claim 10, wherein:
the first electrode includes a first electrode foil, and a first electrode active material layer covering a part of the first electrode foil;
the first electrode includes a first electrode covered part in which the first electrode foil is covered with the first electrode active material layer, and a first electrode exposed part exposed from the first electrode active material layer,; and
a portion, of the first electrode exposed part, that protrudes from a first edge in a width direction of the separator has a length greater than a length of a portion, of the second electrode exposed part, that protrudes from a second edge in the width direction of the separator.

16. The secondary battery according to claim 10, wherein
the first electrode comprises a positive electrode, the second electrode comprises a negative electrode, the first electrode includes a first electrode foil, and a first electrode active material layer covering a part of the first electrode foil, and
the first electrode foil has a Young's modulus lower than a Young's modulus of the second electrode foil.

17. The secondary battery according to claim 10, wherein
the first electrode includes a first electrode foil, and a first electrode active material layer covering a part of the first electrode foil,
the first electrode foil includes aluminum, and
the second electrode foil includes copper.

18. The secondary battery according to claim 10, wherein
each of the first end and the second end is provided with one or more grooves.

19. A secondary battery comprising:
an electrode wound body including a first electrode, a second electrode, and a separator interposed therebetween, and having a first end and a second end;
a first electrode current collector plate connected to the first end; and
a second electrode current collector plate connected to the second end, wherein
the first electrode includes a first electrode foil, and a first electrode active material layer covering a part of the first electrode foil,
the first electrode includes a first electrode covered part in which the first electrode foil is covered with the first electrode active material layer, and a first electrode exposed part exposed from first electrode active material layer,
the first electrode exposed part is bent and includes first electrode-foil adjacent portions adjacent to each other at the first end,
the second electrode includes a second electrode foil, and a second electrode active material layer covering a part of the second electrode foil,
the second electrode includes a second electrode covered part in which the second electrode foil is covered with the second electrode active material layer, and a second electrode exposed part exposed from the second electrode active material layer,
the second electrode exposed part is bent and includes second electrode-foil adjacent portions adjacent to each other at the second end,
a part of the separator is bent, and
the separator is spaced from the first electrode current collector plate and the second electrode current collector plate.

20. The secondary battery according to claim 19, wherein an end of the separator is between the first current electrode collector and the second active material layer.

21. The secondary battery according to claim 19, wherein an end of the separator is between the first adjacent portions and the second active material layer.

22. The secondary battery according to claim 19, wherein an end of the separator is between the second current electrode collector and the first active material layer.

23. The secondary battery according to claim 19, wherein an end of the separator is between the second adjacent portions and the first active material layer.

24. The secondary battery according to claim 19, wherein the secondary battery has a cylindrical shape in outer appearance.

25. The secondary battery according to claim 19, wherein
the first electrode comprises a positive electrode, the second electrode comprises a negative electrode, and
the first electrode exposed part has a width greater than a width of the second electrode exposed part.

26. The secondary battery according to claim 19, wherein
a portion, of the first electrode exposed part, that protrudes from a first edge in a width direction of the separator has a length greater than a length of a portion, of the second electrode exposed part, that protrudes from a second edge in the width direction of the separator.

27. The secondary battery according to claim 19, wherein
the first electrode comprises a positive electrode, the second electrode comprises a negative electrode, and
the first electrode foil has a Young's modulus lower than a Young's modulus of the second electrode foil.

28. The secondary battery according to claim 19, wherein the first electrode foil includes aluminum, and
the second electrode foil includes copper.

29. The secondary battery according to claim 19, wherein
each of the first end and the second end is provided with one or more grooves.
